(19) United States
(12) Patent Application Publication
(10) Pub. No.: US 2025/0232782 A1
(43) Pub. Date: Jul. 17, 2025

(54) AUDIO PROCESSING METHOD AND APPARATUS, COMPUTER-READABLE STORAGE MEDIUM, AND ELECTRONIC DEVICE

(71) Applicant: XG TECH PTE. LTD., Singapore (SG)

(72) Inventor: Yuxiang HU, Singapore (SG)

(73) Assignee: XG TECH PTE. LTD., Singapore (SG)

(21) Appl. No.: 19/171,582

(22) Filed: Apr. 7, 2025

(30) Foreign Application Priority Data
May 31, 2024 (CN) 202410702958.9

(51) Int. Cl. G10L 21/0272; G10L 25/30

(52) U.S. Cl. CPC G10L 21/0272; G10L 25/30

(57) ABSTRACT

Embodiments of the present disclosure disclose an audio processing method and apparatus, a computer-readable storage medium, and electronic device. The method includes: acquiring a first audio signal in a space of a mobile terminal; performing separation processing on the first audio signal to obtain at least two paths of second audio signals; and performing sound effect processing on the at least two paths of second audio signals respectively to correspondingly obtain at least two paths of third audio signals.

### CROSS-REFERENCE TO RELATED APPLICATION

The present disclosure claims priority to Chinese Patent Application No. 202410702958.9, filed on May 31, 2024, which is incorporated herein by reference in its entirety.

### FIELD OF THE PRESENT DISCLOSURE

The present disclosure relates to the technical field of speech processing, and more particularly to an audio processing method and apparatus, a computer-readable storage medium, and electronic device.

### BACKGROUND OF THE PRESENT DISCLOSURE

With the development of Internet of Vehicles, automobiles have evolved from the most basic travel tools to a mobile terminal that can provide more services, and vehicle-mounted intelligent terminals have also become increasingly intelligent. In addition to providing the most basic driving data, more entertainment services, such as music, navigation, and speech interaction, may also be provided. Users have put forward higher and more requirements for vehicle-mounted application services, such as karaoke singing in a vehicle.

### SUMMARY OF THE PRESENT DISCLOSURE

The present disclosure provides an audio processing method and apparatus, a computer-readable storage medium, and electronic device.

According to one aspect of an embodiment of the present disclosure, there is provided an audio processing method, including:
acquiring a first audio signal in a space of a mobile terminal;
performing separation processing on the first audio signal to obtain at least two paths of second audio signals; and
performing sound effect processing on the at least two paths of second audio signals respectively to correspondingly obtain at least two paths of third audio signals.

According to another aspect of the embodiment of the present disclosure, there is provided an audio processing apparatus, including:
an audio acquisition module configured for acquiring a first audio signal in a space of a mobile terminal;
a signal separation module configured for performing separation processing on the first audio signal to obtain at least two paths of second audio signals; and
a sound effect processing module configured for performing sound effect processing on the at least two paths of second audio signals respectively to correspondingly obtain at least two paths of third audio signals.

According to yet another aspect of the embodiment of the present disclosure, there is provided a computer-readable storage medium storing a computer program thereon, which, when executed by a processor, cause the processor to execute the audio processing method according to any one of the above embodiments.

According to still yet another aspect of the embodiment of the present disclosure, there is provided electronic device, including:
a processor; and
a memory for storing processor-executable instructions;
wherein the processor is configured for reading the executable instructions from the memory and executing the instructions to implement the audio processing method according to any one of the above embodiments.

Based on the audio processing method and apparatus, the computer-readable storage medium, and the electronic device provided in the above embodiments of the present disclosure, the extraction of a human voice signal in the space of the mobile terminal is achieved by performing the separation processing on the first audio signal, so as to obtain a relatively pure independent human voice signal in the mobile terminal, namely, the second audio signal; and then the sound effect processing is provided for different human voice signals by performing the corresponding sound effect processing on the at least two paths of second audio signals respectively, so as to achieve personalized sound effect processing, thereby satisfying different sound effect requirements of different users during karaoke singing without a microphone, and enhancing the experience of the users during karaoke singing in a mobile space in a scene of karaoke singing without the microphone.

The technical solutions of the present disclosure will be described in further detail below with reference to the accompanying drawings and embodiments.

### BRIEF DESCRIPTION OF THE DRAWINGS

The above and other objects, features and advantages of the present disclosure will become more apparent by describing the embodiments of the present disclosure in further detail in conjunction with the accompanying drawings. The accompanying drawings, which are included to provide a further understanding of the embodiments of the present disclosure and constitute a part of the specification, are used for explaining the present disclosure together with the embodiments of the present disclosure, and are not intended to limit the present disclosure. In the drawings, like reference numerals generally represent like components or steps.

FIG. 1 is a schematic flow diagram of an audio processing method provided in an illustrative embodiment of the present disclosure;

FIG. 2 is a schematic flow diagram of sound effect processing in the audio processing method provided in an illustrative embodiment of the present disclosure;

FIG. 3 is a schematic flow diagram of the audio processing method provided in another illustrative embodiment of the present disclosure;

FIG. 4 is a schematic structural diagram of an audio processing apparatus provided in an illustrative embodiment of the present disclosure;

FIG. 5 is a schematic structural diagram of the audio processing apparatus provided in another illustrative embodiment of the present disclosure;

FIG. 6 is a schematic structural diagram of the audio processing apparatus provided in yet another illustrative embodiment of the present disclosure;

FIG. 7 is a schematic structural diagram of the audio processing apparatus provided in still yet another illustrative embodiment of the present disclosure; and

FIG. 8 is a structural diagram of electronic device provided in an illustrative embodiment of the present disclosure.

### DESCRIPTION OF THE EMBODIMENTS

In order to explain the present disclosure, the illustrative embodiments of the present disclosure will be described in detail below with reference to the accompanying drawings. It is apparent that the described embodiments are only some embodiments, but not all embodiments of the present disclosure, and it should be understood that the present disclosure is not limited to the illustrative embodiments.

It should be noted that the relative arrangement of components and steps, numerical expressions, and numerical values set forth in these embodiments do not limit the scope of the present disclosure, unless specifically stated otherwise.

### SUMMARY OF THE APPLICATION

In the process of implementing the present disclosure, the inventor have found that karaoke singing without a microphone refers to a karaoke singing manner in which singing may be performed without a hand-held microphone, and vehicle-mounted karaoke singing without a microphone is a manner in which karaoke singing without the microphone is achieved by an existing microphone in a vehicle, such as a built-in microphone of the vehicle, and external device (such as the hand-held microphone) is not needed, thereby reducing the external device, greatly improving the usage experience and usage willingness of a user, and making the vehicle more humanized and scientific. Moreover, the problems that the cost is relatively high, singers cannot be flexibly switched, and the like since an in-vehicle microphone needs to be purchased and installed in advance are solved. However, for the current vehicle-mounted karaoke singing without the microphone, a uniform sound effect is used for all passengers in the vehicle. For different passengers in the vehicle, it is difficult for a single sound effect to meet karaoke singing requirements of the different passengers.

### Illustrative Method

In order to improve the user experience of the above karaoke singing without the microphone, the present disclosure provides a personalized sound effect processing method which may provide different sound effect experiences for different users. FIG. 1 is a schematic flow diagram of an illustrative audio processing method of the present disclosure. This embodiment may be applied to electronic device, as shown in FIG. 1, the audio processing method includes the following steps.

Step 102, acquiring a first audio signal in a space of a mobile terminal.

The mobile terminal may be manned mobile device, such as a vehicle, flight device (such as an airplane and aircraft), and watercraft. The first audio signal may be an audio signal which is mixed with at least one sound signal in the mobile terminal. In this embodiment, with regard to the case of audio acquisition without a microphone, it is unnecessary to newly add hardware device separately, and the first audio signal may be picked up and acquired by pickup device such as a built-in microphone of the mobile terminal. For embodiment, the first audio signal includes sound signals of two passengers and noise signals inside and outside the mobile terminal.

Step 104, performing separation processing on the first audio signal to obtain at least two paths of second audio signals.

In an embodiment, the first audio signal may be separated into at least two paths of second audio signals corresponding to at least two sound sources by a sound separation technology. Optionally, the sound separation technology may include, but are not limited to: a spectral subtraction method, a sound source localization method, an artificial intelligence sound separation method, and the like. The spectral subtraction method is a sound separation method based on frequency-domain analysis, in which sound separation is achieved by calculating frequency-domain differences between mixed signals and original signals and applying these differences to frequency spectra of the mixed signals. Sound source localization is a method for determining a sound source location by analyzing information such as arrival time differences, amplitude differences and phase differences of sound in different pickup device. The artificial intelligence sound separation method is a sound separation algorithm which utilizes machine learning and a deep neural network.

Step 106, performing sound effect processing on the at least two paths of second audio signals respectively to correspondingly obtain at least two paths of third audio signals.

Optionally, each path of second audio signal corresponds to one path of third audio signal, and the third audio signal is an audio signal obtained after the second audio signal is subjected to the sound effect processing.

A sound effect refers to an effect produced to sound, and refers to noise or sound added to audio so as to enhance the sense of reality, atmosphere or a dramatic message of a scene, the sound therein may include musical sound and effect sound, such as a digital sound effect, an environmental sound effect, and the like, and audio commonly used in a KTV scene is the environmental sound effect.

The first audio signal, the second audio signal and the third audio signal in this embodiment may all be time-domain sound signals or frequency-domain sound signals (obtained by performing time-frequency-domain conversion on the acquired time-domain sound signals), wherein first, second and third are only used for distinguishing audio signals which are subjected to different processing.

According to the audio processing method provided in the above embodiment of the present disclosure, the extraction of a human voice signal in the space of the mobile terminal is achieved by performing the separation processing on the first audio signal, so as to obtain a relatively pure human voice signal in the mobile terminal, namely, the second audio signal; and then the sound effect processing is provided for different human voice signals by performing the corresponding sound effect processing on the at least two paths of second audio signals respectively, so as to achieve personalized sound effect processing, thereby satisfying different sound effect requirements of different users during karaoke singing without a microphone, and enhancing the experience of the users during karaoke singing in a mobile space in a scene of karaoke singing without the microphone.

In some optional embodiments, step 104 may include:
inputting the first audio signal into a first neural network model, and outputting the at least two paths of second audio signals respectively by at least two output channels of the first neural network model, wherein the first neural network model may be pre-trained.

Illustratively, the number of the second audio signals may be the number of audio zones in the mobile terminal, for embodiment, when the mobile terminal is a vehicle, there are four audio zones in the vehicle, including a main driver audio zone, an assistant driver audio zone, a rear left audio zone and a rear right audio zone, and correspondingly four paths of second audio signals will be obtained after the separation processing. The number of the audio zones in the embodiment of the present disclosure may be equal to the number of built-in microphone arrays of the vehicle, for embodiment, each audio zone described above is equipped with one microphone array. Alternatively, the number of the audio zones in the embodiment of the present disclosure may not be equal to the number of the built-in microphone arrays of the vehicle, for embodiment, some of the audio zones are equipped with at least one microphone array, and some of the audio zones are not equipped with the microphone arrays. Illustratively, the main driver audio zone is provided with one microphone array, the assistant driver audio zone is provided with one microphone array, the rear left audio zone and the rear right audio zone are provided with one microphone array together, and in this case, it may be considered that the number of the audio zones is not equal to the number of the microphone arrays. A corresponding relationship between the number of the audio zones and the number of the microphone arrays is not limited in the present disclosure.

In this embodiment, the first audio signal may be a time-domain signal or a frequency-domain signal, the first audio signal may be directly input into the first neural network model, and at least two paths of second audio signals may be directly obtained by the first neural network model. After the first audio signal is processed, the processed data may also be input into the first neural network model, for embodiment, short-time Fourier transform may be performed on the first audio signal to obtain an amplitude spectrum and a phase spectrum of the first audio signal; the amplitude spectrum of the first audio signal is input into the first neural network model, so as to obtain a human voice amplitude spectrum and other amplitude spectra in the first audio signal; and inverse short-time Fourier transform is performed on the human voice amplitude spectrum, the other amplitude spectra and the phase spectrum of the first audio signal to obtain the separated second audio signal (such as human voice signal data or other signal data).

In this embodiment, a network structure of the first neural network model is not limited, and optionally the first neural network model is trained by utilizing a sample audio signal of a known separation result signal before the separation processing is executed by utilizing the first neural network model. Optionally, mobile terminals of different types and models may be trained by adopting different sample audio signals to adapt to the mobile terminals of corresponding types and models, thereby improving the accuracy of the first neural network model in separating the first audio signal. Illustratively, the types of the mobile terminals may include terminal device which moves in different media, such as a vehicle, flight device and watercraft. Illustratively, when the mobile terminal is the vehicle, the model of the mobile terminal may include vehicles with different sizes of spaces and/or different numbers of audio zones, such as saloon cars, sports cars, pickup trucks and SUVs.

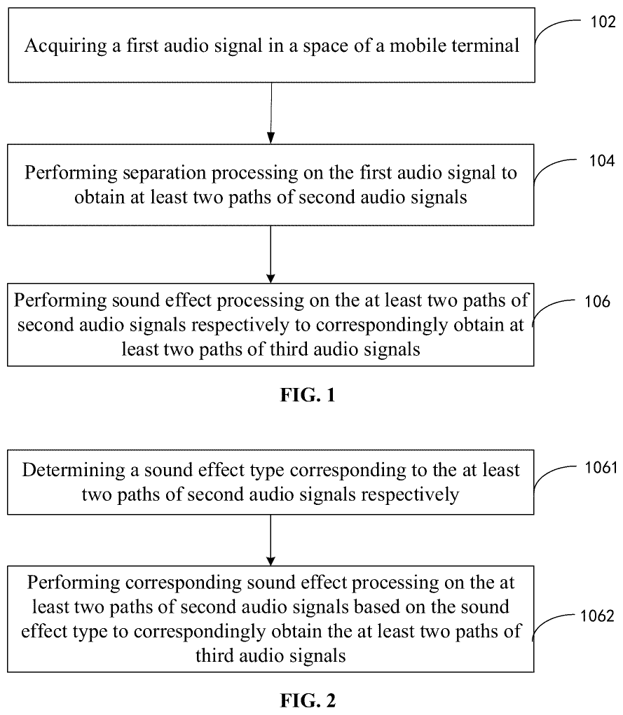

As shown in FIG. 2, step 106 may include the following steps on the basis of the above embodiment shown in FIG. 1.

Step 1061, determining a sound effect type corresponding to the at least two paths of second audio signals respectively.

The sound effect types in this embodiment may include, but are not limited to: an equalized sound effect, an artificial reverberation sound effect, a tone modified sound effect, a human voice enhanced sound effect, a style conversion sound effect, and the like.

Optionally, each path of second audio signal corresponds to at least one sound effect type, and/or one sound effect type corresponds to at least one path of second audio signal.

In some optional embodiments, the sound effect type may be determined according to an indication which is externally input (for example, input by a user emitting human voice in the mobile terminal), and optionally, the sound effect type corresponding to the at least two paths of second audio signals is determined according to a first sound effect indication.

In this embodiment, at least one first sound effect indication may be received simultaneously. Optionally, at least two first sound effect indications correspond to at least two sound effect types (each first sound effect indication corresponds to one sound effect type), or one first sound effect indication corresponds to at least two sound effect types; for example, one human voice enhanced sound effect is determined by receiving one first sound effect indication; and for another example, one tone modified sound effect and one equalized sound effect are at least determined by receiving one first sound effect, and the like. The sound effect type is determined by the sound effect indication, so that the corresponding sound effect type is determined according to active selection of the user, the participation degree of the user is improved, and the third audio signal which better meets the needs of the user may be obtained. Alternatively, the sound effect types of at least two users may be determined by receiving one first sound effect indication, so that the operation of the user may be further simplified, and the sound effect processing for different users may be achieved by the indication operation of one user.

The first sound effect indication described in the present disclosure may include a speech indication, a visual indication, a gesture indication, a text indication or an operation indication, and the like of the user, and the type of the first sound effect indication is not limited in the present application.

In some other optional embodiments, the sound effect type may be automatically determined according to feature information of the user. Optionally, the sound effect type corresponding to the at least two paths of second audio signals is determined according to the feature information of the user.

In this embodiment, the feature information of the user may be obtained by acquiring user information through built-in device of the mobile terminal and processing the user information; for example, an image of the user is acquired by a built-in camera, and the feature information of the user, such as age and gender of the user, is determined through identification of the image. Optionally, the feature information of the user may also be obtained by user input. Optionally, at least two sound effect types may be determined according to at least two sets of feature information of the user (one sound effect type is determined by each set of feature information of the user), or at least two sound effect types may be determined according to one set of feature information of the user, wherein corresponding relationships between different feature information of the user and different sound effect types may be pre-stored in the mobile terminal, and illustratively the corresponding relationships may be stored in the mobile terminal in the form of a table, so that the process of determining the sound effect type according to the feature information of the user may be obtained by querying the table, for example, at least one sound effect type corresponding to each set of feature information of the user among a plurality of sets of feature information of the user in a preset table is determined statistically through big data, and each set of feature information of the user includes at least one feature data of the user. In this embodiment, the automatic matching of the sound effect types is achieved through the feature information of the user, thereby improving the efficiency of determination of the sound effect types.

Optionally, the feature information of the user may include multi-modal information of the user, and the multi-modal information refers to information extracted and fused from data of different modalities (namely, different types or sources). Such information not only includes multimedia data such as text, images, audio and video, but also involves comprehensive processing and fusion of these data. In this embodiment, the multi-modal information of the user may include, but is not limited to, the information such as the gender and age of the user obtained based on the processing on multimedia data such as an image, audio and video of the user (the image, audio, video, and the like may be processed by a deep neural network model).

In an optional instance, the sound effect type corresponding to the at least two paths of second audio signals is obtained from a sound effect library according to the multi-modal information.

A plurality of sound effect types are pre-stored in the sound effect library. Optionally, the plurality of sound effect types are pre-stored in the sound effect library, and a sound effect processing method corresponding to each sound effect type is also stored. In this embodiment, after the multi-modal information of the user is determined, the corresponding sound effect type may be automatically selected for the user according to the multi-modal information; and for example, the multi-modal information of one user includes that the gender is female and the age is about 20 years old, and the corresponding tone modified sound effect and style conversion sound effect may be determined according to table look-up, namely, in this embodiment, the automatic matching of the sound effect type and the second audio signal is achieved by the multi-modal information, thereby improving the efficiency of determination of the sound effect types.

Step 1062, performing corresponding sound effect processing on the at least two paths of second audio signals based on the sound effect type to correspondingly obtain the at least two paths of third audio signals.

Optionally, different sound effect types correspond to different sound effect processing methods, and optionally, one sound effect type corresponds to one sound effect processing method, for example, an equalized sound effect corresponds to an audio equalizing method, a tone modified sound effect corresponds to an audio tone modifying method, and the like. After the sound effect type is determined, the second audio signal is processed into a third audio signal of a corresponding sound effect type by the sound effect processing method.

In this embodiment, the third audio signal with the corresponding sound effect is obtained by determining the corresponding sound effect type for the second audio signal and processing the second audio signal based on the sound effect processing method of the corresponding sound effect type.

In some optional embodiments, since there are a number of noise signals, such as air conditioner noise, wind noise, tire noise, and coughing and applause of passengers in the vehicle, which are not related to sound signals needing to be acquired inside the mobile terminal (such as the vehicle), and the presence of the noise signals may affect the proportion of human voice signals in signals played by a loudspeaker, and interfere with the experience of the user during karaoke singing. Therefore, before the sound effect processing is performed on the second audio signal, the method may also include:

performing noise suppression processing on the at least two paths of second audio signals respectively.

In this embodiment, noise suppression for each path of second audio signal may be achieved by utilizing a noise suppression method. For example, the second audio signal is processed by utilizing a noise suppression network model, and the second audio signal after noise suppression is output. The noise suppression network model is a deep neural network with an arbitrary network structure, which, before performing noise suppression, is trained with a training set including a large number of original sound signals paired with their corresponding noise-suppressed versions. By training the noise suppression network model, a better noise suppression effect may be achieved.

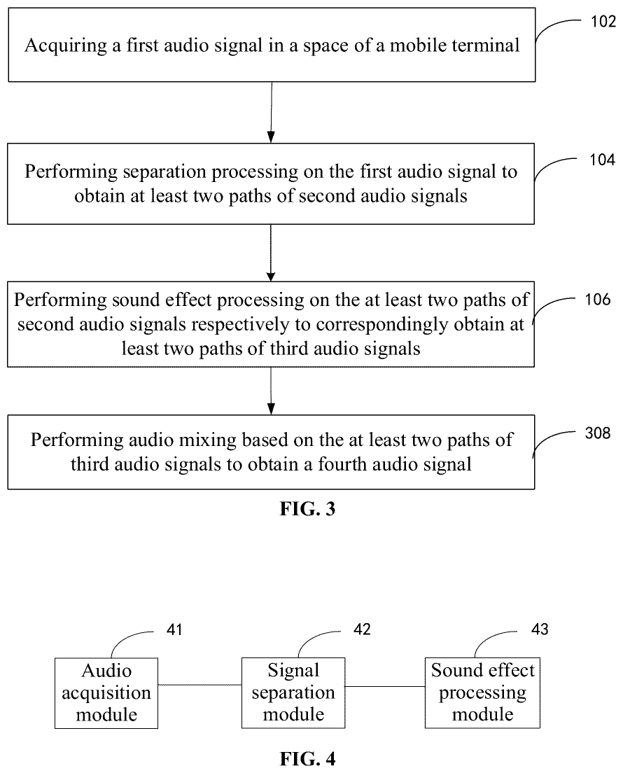

FIG. 3 is a schematic flow diagram of the audio processing method provided in another illustrative embodiment of the present disclosure. This embodiment may be applied to electronic device, as shown in FIG. 3, the audio processing method includes the following steps.

Step 102, acquiring a first audio signal in a space of a mobile terminal.

Step 104, performing separation processing on the first audio signal to obtain at least two paths of second audio signals.

Step 106, performing sound effect processing on the at least two paths of second audio signals respectively to correspondingly obtain at least two paths of third audio signals.

Step 308, performing audio mixing based on the at least two paths of third audio signals to obtain a fourth audio signal.

In this embodiment, the sound effect processing is executed on the at least two paths of second audio signals obtained by separating the first audio signal respectively to obtain the at least two paths of third audio signals. However, due to the limitation of sound playing device in the mobile terminal, and due to the limited space in the mobile terminal, the effect of playing the at least two paths of third audio signals respectively is not much different from the effect of playing the at least two paths of third audio signals after the third audio signals are mixed. Therefore, in this embodiment, the at least two paths of third audio signals after being subjected to different sound effect processing are mixed into one path of fourth audio signal. Optionally, in some embodiments, the processing on the at least two paths of third audio signals may include:
executing signal superposition on the at least two paths of third audio signals to obtain a fifth audio signal.

Optionally, when the third audio signals are time-domain signals, the at least two paths of third audio signals are combined according to time, namely, the superposition of the at least two paths of third audio signals is completed to obtain one path of fifth audio signal.

In this embodiment, the fifth audio signal may be a single-channel or multi-channel signal, the number of channels is not related to the number of paths of the audio signals (such as the third audio signals in this embodiment), and at least two paths of audio signals represent at least two different audio signals. The channel refers to a path through which the audio signal (the fifth audio signal in this embodiment) is transmitted, and controls an output location and a size of the audio signal in the loudspeaker. For embodiment, in a multi-track ambiophonic system, different channels such as a front central channel, a subwoofer channel, a left front track, a right front track, a left rear track and a right rear track are included; and the fifth audio signal in this embodiment is generally the single-channel signal, and when the fifth audio signal is the multi-channel signal, the number of channels is determined according to the number of channels reserved by a DSP power amplifier. In addition, a signal superposition method may be preset according to the DSP power amplifier. The DSP power amplifier refers to a power amplifier for optimizing and managing audio parameters through a digital signal processing algorithm by adopting a DSP chip, and is a technology for changing a two-track stereo signal into a multi-track ambiophonic signal. In addition to having the functions of other power amplifiers, the DSP power amplifier may attenuate the frequencies overlapped by an in-vehicle environment and add the frequencies attenuated by the environment, and may also adjust a distance between each horn in the vehicle and a human ear, and the like. The DSP power amplifier may adjust defects which cannot be adjusted physically.

In some embodiments, the processing on the at least two paths of third audio signals may further include: performing audio mixing processing on the fifth audio signal and a preset signal to obtain the fourth audio signal.

Optionally, when this embodiment is applied to a karaoke singing scene, the preset signal may be a preset accompaniment signal, and the fourth audio signal may be a karaoke singing sound signal in which a human voice signal and the preset accompaniment signal are mixed. Audio mixing is a step in audio production, in which sound from a plurality of sources is integrated into a stereo audio track or monophonic audio track. Sound sources in this embodiment are the fifth audio signal and the preset signal, for example, the human voice audio signal and the preset accompaniment signal. After the fourth audio signal is obtained, this embodiment may further include: playing the fourth audio signal inside the space of the mobile terminal, and/or outside the space of the mobile terminal.

Optionally, the fourth audio signal may be played by the loudspeaker provided on the mobile terminal, and karaoke singing may be achieved without newly adding other hardware device. For example, when the mobile terminal is the vehicle, the built-in loudspeaker of the vehicle plays the fourth audio signal, or an external loudspeaker of the vehicle plays the fourth audio signal, so that in-vehicle or out-of-vehicle karaoke singing experience may be achieved, or the fourth audio signal is played by the built-in loudspeaker and the external loudspeaker of the vehicle simultaneously, so as to achieve the in-vehicle and out-of-vehicle karaoke singing experience.

In some optional embodiments, the first audio signal may be an audio signal in which a plurality of sound is mixed in the mobile terminal, and optionally, the acquiring a first audio signal may include:
acquiring sound signals at a plurality of locations in the space of the mobile terminal by a plurality of microphones to obtain the first audio signal.

In this embodiment, the acoustic sensor is sound acquisition device such as a microphone or microphone array which may achieve sound acquisition. The mobile terminal may internally include a plurality of locations (corresponding to a plurality of audio zones), for example, when the mobile terminal is the vehicle, there are four locations (corresponding to four audio zones, including a main driver audio zone, an assistant driver audio zone, a rear left audio zone and a rear right audio zone) in a space of the vehicle, and the acquisition of sound signals at the plurality of locations are achieved by providing the plurality of acoustic sensors. For example, each location is equipped with one microphone array; and for another example, at least two locations are equipped with one microphone array; and each location may also be correspondingly equipped with at least one microphone array. In this embodiment, the sound signals are acquired at a plurality of locations by the plurality of acoustic sensors to obtain one path of first audio signal in which the sound signals at the plurality of locations are mixed, so that the sound signals at the plurality of locations in the mobile terminal all participate in signal separation and sound effect processing, and the problem of signal omission caused by incomplete pickup is reduced. For example, the first audio signal may include four paths of first sub-audio signals acquired at four locations (audio zones) respectively.

In some optional embodiments, the acquiring the first audio signal may include:
acquiring a sixth audio signal in the space of the mobile terminal.

In this embodiment, the sixth audio signal may be sound signals acquired at a plurality of locations (corresponding to a plurality of audio zones) in the space of the mobile terminal by a plurality of acoustic sensors, and optionally, each location of the plurality of locations corresponds to one sixth audio signal. At this time, the sixth audio signal is a mixed sound signal, and since there is further at least internally included the fourth audio signal played by the loudspeaker in the mobile terminal, if interference suppression processing is not performed on the sixth audio signal, greater interference will be caused to the sixth audio signal in the mobile terminal.

And the acquiring the first audio signal may further include: eliminating an interference signal in the sixth audio signal to obtain the first audio signal.

In this embodiment, the fourth audio signal played by the loudspeaker is taken as a main interference signal in the mobile terminal, and if the interference signal in the sixth audio signal is not eliminated, the first audio signal will be caused to not only include the first audio signal needing to be acquired, but also include the fourth audio signal played by the loudspeaker synchronously, thereby resulting in greater echo interference in the first audio signal. In this embodiment, by eliminating the interference signal, the echo interference in the first audio signal is avoided, and the accuracy of audio acquisition is improved. In addition, the eliminating an interference signal may include:

performing interference signal elimination processing on the sixth audio
signal based on a reference signal determined based on the fourth audio signal to obtain the first audio signal.

The reference signal is determined based on the fourth audio signal. Optionally, the fourth audio signal is taken as the reference signal, and at this time, the played fourth audio signal is directly acquired from a playing end of the loudspeaker as the reference signal, without acquiring the reference signal by an additional technical means.

In this embodiment, the interference signal elimination processing performed by utilizing the reference signal may be achieved by utilizing an estimation filter, for example, the reference signal and the sixth audio signal are respectively input into the estimation filter, and the sound signal the same as the reference signal in the sixth audio signal is filtered by the estimation filter to achieve the interference signal elimination. Optionally, the estimation filter is determined according to a path between the acoustic sensor and the microphone, for example, the known signal may be played in advance by the microphone, and the estimation of the filter is achieved by utilizing the known signal which is played by the microphone and acquired by the acoustic sensor to obtain the estimation filter. In this embodiment, the signal loss of the reference signal propagating from the loudspeaker to the acoustic sensor is simulated by the estimation filter, so that the interference elimination is more accurate and the obtained first audio signal is not affected by the sound signal played by the loudspeaker.

According to the audio processing method provided in yet another illustrative embodiment of the present disclosure, this embodiment is applied to an in-vehicle karaoke singing scene, wherein the mobile terminal is a vehicle including four audio zones. The method provided in this embodiment may include the following steps.

Sound signals inside the vehicle are acquired by four acoustic sensors (for example, a microphone or a microphone array), each acoustic sensor corresponds to one audio zone in the vehicle, and the sound signals emitted from the corresponding audio zone are acquired to obtain four paths of sixth audio signals.

Interference signal elimination processing is performed on the four paths of sixth audio signals respectively based on the reference signal to obtain four paths of first sub-audio signals after interference signals are eliminated, and the four paths of first sub-audio signals are mixed to obtain the first audio signal, wherein the reference signal is determined based on the fourth audio signal.

Separation processing is performed on the first audio signal to obtain four paths of second audio signals. Each path of second audio signal corresponds to one audio zone in the vehicle.

Noise suppression is executed on each path of second audio signal among the four paths of second audio signals respectively to obtain four paths of second noise-suppressed audio signals.

Sound effect processing is performed on the four paths of second noise-suppressed audio signals respectively to correspondingly obtain four paths of third audio signals, wherein the four paths of second audio signals may correspond to the same or different sound effects, for example, the sound effect processing is performed on the four paths of second audio signals respectively by adopting a sound effect A, a sound effect B, a sound effect C and a sound effect D to obtain four paths of third audio signals after sound effect processing. For another example, the sound effect processing is performed on two paths of second audio signals by adopting a sound effect E, the sound effect processing is performed on one path of second audio signal by adopting a sound effect F, and the sound effect processing is performed on one path of second audio signal by adopting a sound effect G. For another example, the sound effect processing is performed on the four paths of second audio signals by adopting a sound effect H.

After the four paths of third audio signals are obtained, in order to facilitate playing, signal superposition is executed on the four paths of third audio signals to obtain one path of fifth audio signal, wherein the fifth audio signal is a mixed human voice signal.

Since an application scene of this embodiment is the karaoke singing scene, accompaniment audio in a corresponding karaoke singing application is further included, and audio mixing processing is performed on the fifth audio signal and a preset accompaniment signal to obtain one path of fourth audio signal. The fourth audio signal is played by a built-in loudspeaker of the vehicle.

The fourth audio signal obtained in the above embodiment is also taken as a reference signal to achieve interference signal elimination processing on the sixth audio signal.

Any of the audio processing methods provided in the embodiments of the present disclosure may be executed by any suitable device having data processing capabilities, including, but not limited to: terminal device and a server, and the like. Alternatively any of the audio processing methods provided in the embodiments of the present disclosure may be executed by a processor, for example, the processor executes any of the audio processing methods mentioned in the embodiments of the present disclosure by calling corresponding instructions stored in a memory. A detailed description is omitted below.

The steps of the methods provided in the embodiments of the present disclosure may be arbitrarily combined/added/deleted on the premise that the steps may be implemented.

### Illustrative Apparatus

FIG. 4 is a schematic structural diagram of an audio processing apparatus provided in an illustrative embodiment of the present disclosure. As shown in FIG. 4, the apparatus provided in this embodiment includes:
an audio acquisition module 41 configured for acquiring a first audio signal in a space of a mobile terminal; optionally, the audio acquisition module being merely an illustrative way to name, wherein the module may also be referred to as an audio acquisition module, an audio pickup module, and the like;
a signal separation module 42 configured for performing separation processing on the first audio signal to obtain at least two paths of second audio signals; and
a sound effect processing module 43 configured for performing sound effect processing on the at least two paths of second audio signals respectively to correspondingly obtain at least two paths of third audio signals.

For the audio processing apparatus provided in the above embodiment of the present disclosure, the extraction of a human voice signal in the space of the mobile terminal is achieved by performing the separation processing on the first audio signal, so as to obtain a relatively pure human voice signal in the mobile terminal, namely, the second audio signal; and then the sound effect processing is provided for different human voice signals by performing the corresponding sound effect processing on the at least two paths of second audio signals respectively, so as to achieve personalized sound effect processing, thereby satisfying different sound effect requirements of different users, and enhancing the experience of the users during karaoke singing in a mobile space.

In some optional embodiments, the signal separation module 42 is specifically configured for obtaining the at least two paths of second audio signals by a first neural network model.

Optionally, the first audio signal is input into the first neural network model, and the at least two paths of second audio signals are output respectively by at least two output channels of the first neural network model, wherein each output channel correspondingly outputs one path of second audio signal.

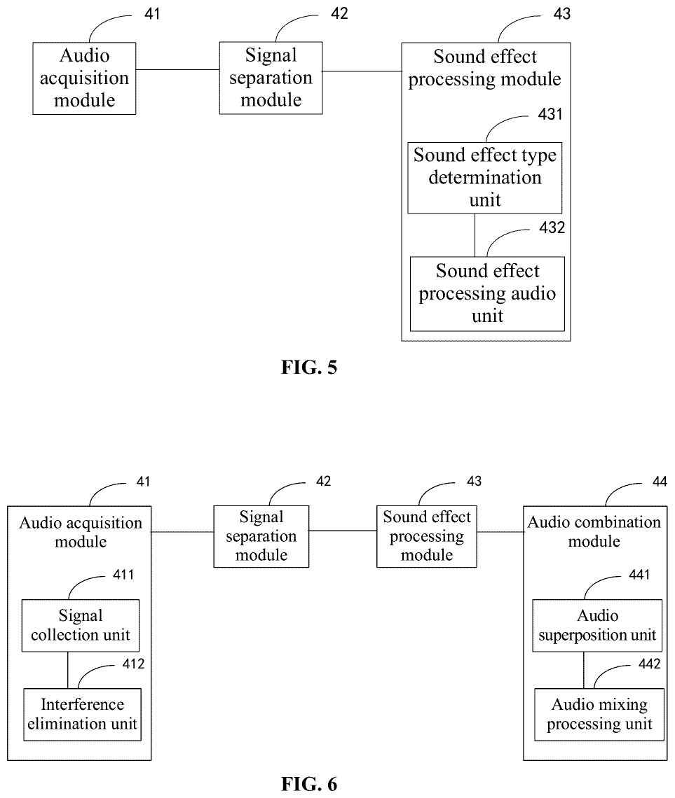

FIG. 5 is a schematic structural diagram of the audio processing apparatus provided in another illustrative embodiment of the present disclosure. As shown in FIG. 5, the sound effect processing module 43 in the apparatus provided in this embodiment may further include:
a sound effect type determination unit 431 configured for determining a sound effect type corresponding to the at least two paths of second audio signals respectively.

In some instances, the sound effect type determination unit 431 is specifically configured for determining the sound effect type corresponding to the at least two paths of second audio signals according to a first sound effect indication to achieve manual sound effect setting by a user.

In some other instances, the sound effect type determination unit 431 is specifically configured for determining the sound effect type corresponding to the at least two paths of second audio signals according to feature information of the user to automatically assign the sound effect type matching the feature thereof to the user and achieve automated implementation of personalized sound effects. Optionally, the feature information of the user includes multi-modal information of the user; and the sound effect type determination unit 431 is specifically configured for acquiring the sound effect type corresponding to the at least two paths of second audio signals from a sound effect library according to the multi-modal information. For example, when the multi-modal information is image data of the user, the image data of the user is identified by a deep neural network model, and information such as gender and age of the user, and the like is determined; and table look-up is performed according to the gender and age information of the user, and the sound effect type corresponding to the user is determined. Before the image data of the user is identified by applying the deep neural network model, the deep neural network model is trained with a set of image data of known gender and age.

The sound effect processing audio unit 432 is configured for performing corresponding sound effect processing on the at least two paths of second audio signals based on the sound effect type to correspondingly obtain the at least two paths of third audio signals.

FIG. 6 is a schematic structural diagram of the audio processing apparatus provided in yet another illustrative embodiment of the present disclosure. As shown in FIG. 6, the apparatus provided in this embodiment further includes:
an audio combination module 44 configured for performing audio mixing based on the at least two paths of third audio signals to obtain a fourth audio signal.

Optionally, the audio combination module 44 includes:
an audio superposition unit 441 configured for executing signal superposition on the at least two paths of third audio signals to obtain a fifth audio signal.

Optionally, when the third audio signals are time-domain signals, the at least two paths of third audio signals are combined according to time, namely, the superposition of the at least two paths of third audio signals is completed to obtain the fifth audio signal.

Optionally, the audio combination module 44 further includes: an audio mixing processing unit 442 is configured for performing audio mixing processing on the fifth audio signal and a preset signal to obtain the fourth audio signal.

In some optional embodiments, the audio acquisition module 41 is specifically configured for acquiring sound signals at a plurality of locations in the space of the mobile terminal by a plurality of acoustic sensors to obtain the first audio signal.

In this embodiment, the acoustic sensor may be sound acquisition device in any form such as a microphone or microphone array which is applicable to this embodiment only by achieving sound pickup.

In some other optional embodiments, the audio acquisition module 41 includes:
a signal acquisition unit 411 configured for acquiring a sixth audio signal in the space of the mobile terminal; and
an interference elimination unit 412 configured for eliminating an interference signal in the sixth audio signal to obtain the first audio signal.

Optionally, the interference elimination unit is specifically configured for performing interference signal elimination processing on the sixth audio signal based on a reference signal to obtain the first audio signal; and the reference signal is determined based on the fourth audio signal.

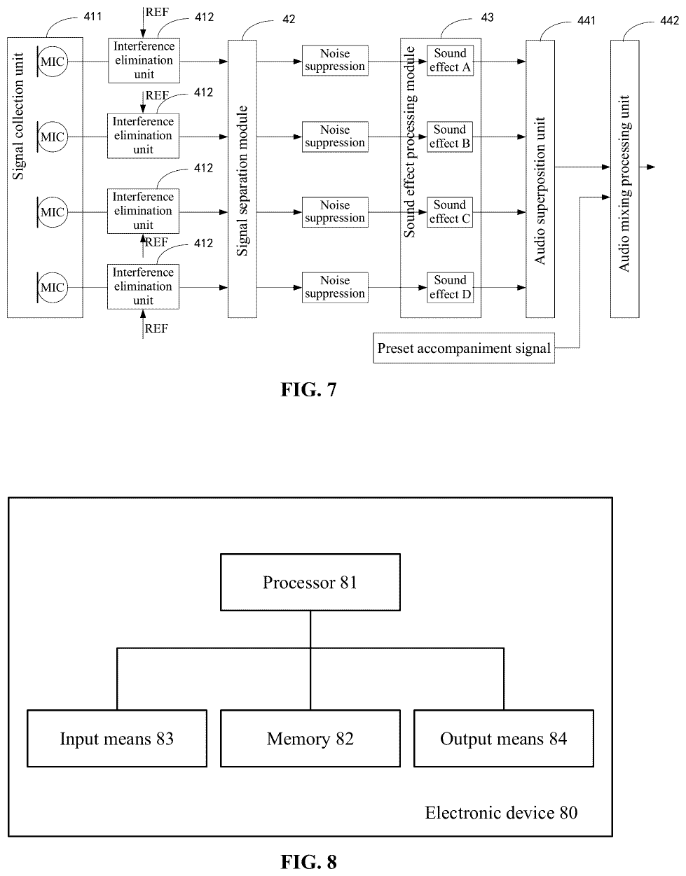

FIG. 7 is a schematic structural diagram of the audio processing apparatus provided in still yet another illustrative embodiment of the present disclosure. As shown in FIG. 7, this embodiment is applied to an in-vehicle karaoke singing scene, wherein the mobile terminal is a vehicle including four audio zones. The apparatus provided in this embodiment includes that:

the signal acquisition unit 411 includes four microphones (MICs), wherein each microphone corresponds to one audio zone in the vehicle, and acquires sound signals emitted by the corresponding audio zone to obtain four paths of microphone signals (corresponding to four paths of sixth audio signals).

The interference elimination units 412 respectively correspond to the four paths of sixth audio signals, and are configured for performing interference signal elimination processing on the four paths of sixth audio signals based on a reference signal, four paths of first sub-audio signals are respectively obtained from the four paths of sixth interference cancelled audio signals, and the four paths of first sub-audio signals are mixed to obtain the first audio signal, wherein the reference signal is determined based on the fourth audio signal.

In some embodiments, the signal separation module 42 is configured for performing separation processing on the first audio signal to obtain four paths of second audio signals. Each path of second audio signal corresponds to one audio zone in the vehicle.

Noise suppression is executed on each path of second audio signal respectively and then the second audio signals are input into the sound effect processing module 43, and the sound effect processing module 43 performs sound effect processing on the four paths of second audio signals respectively to correspondingly obtain four paths of third audio signals, wherein each path of second audio signal may correspond to different sound effects, for example, as shown in FIG. 7, the sound effect processing is performed on the four paths of second audio signals respectively by adopting a sound effect A, a sound effect B, a sound effect C and a sound effect D to obtain four paths of third audio signals after sound effect processing.

After the four paths of third audio signals are obtained, in order to facilitate playing, signal superposition is executed on the four paths of third audio signals by the audio superposition unit 441 to obtain a fifth audio signal, wherein the fifth audio signal is a mixed human voice signal.

Since an application scene of this embodiment is the karaoke singing scene, accompaniment audio in a corresponding karaoke singing application is further included, and audio mixing processing is performed on the fifth audio signal and a preset accompaniment signal by the audio mixing processing unit 442 to obtain a fourth audio signal. The fourth audio signal is played by a built-in loudspeaker of the vehicle.

The fourth audio signal obtained in the above embodiment is also input into the interference elimination unit 412 as a reference signal to achieve interference signal elimination processing on the sixth audio signal.

Reference may be made to the corresponding beneficial technical effects of the above illustrative method section for beneficial technical effects corresponding to the illustrative embodiment of the apparatus of the present disclosure. A detailed description is omitted herein.

### Illustrative Electronic Device

FIG. 8 is a structural diagram of electronic device provided in an embodiment of the present disclosure, including at least one processor 81 and a memory 82.

The processor 81 may be a central processing unit (CPU) or processing units in other forms having data processing capabilities and/or instruction execution capabilities, and may control other components in the electronic device 80 to execute desired functions.

The memory 82 may include one or more computer program products which may include computer-readable storage media in various forms, such as a volatile memory and/or a non-volatile memory. The volatile memory may include, for example, a random access memory (RAM) and/or a cache, and the like. The non-volatile memory may include, for example, a read-only memory (ROM), a hard disk, a flash memory, and the like. One or more computer program instructions may be stored on the computer-readable storage medium, and the processor 81 may run the one or more computer program instructions to implement the audio processing methods and/or other desired functions of the various embodiments of the present disclosure above.

In one instance, the electronic device 80 may further include: an input means 83 and an output means 84, and these components are interconnected by a bus system and/or connection mechanisms in other forms (not shown).

The input means 83 may further include, for embodiment, a keyboard, a mouse, and the like.

The output means 84 may output various information to the outside, and may include, for example, a display, a loudspeaker, a printer, a communication network and remote output device connected to the communication network, and the like.

Of course, for simplicity, only some of the components in the electronic device 80 related to the present disclosure are shown in FIG. 8, and the components such as buses, input/output interfaces, and the like, are omitted. In addition, the electronic device 80 may further include any other suitable components according to specific application situations.

### Illustrative Computer Program Product and Computer-Readable Storage Medium

In addition to the methods and device above, an embodiment of the present disclosure may further provide a computer program product, including computer program instructions which, when run by a processor, cause the processor to execute the steps in the audio processing methods of various embodiments of the present disclosure described in the “illustrative method” section above.

The computer program product may include program codes for executing the operation of the embodiments of the present disclosure written in one or any combination of more programming languages, and the programming languages include object-oriented programming languages, such as Java and C++, and further include conventional procedural programming languages, such as “C” language or similar programming languages. The program codes may be executed entirely on computing device of the user, executed partially on the computing device of the user, executed as a stand-alone software package, executed partially on the computing device of the user and partially on remote computing device, or executed entirely on the remote computing device or a server.

In addition, an embodiment of the present disclosure may also be a computer-readable storage medium storing thereon a computer program instruction which, when run by a processor, causes the processor to execute the steps in the audio processing methods of various embodiments of the present disclosure described in the “illustrative method” section above.

One or any combination of more readable media may be adopted as the computer-readable storage medium. The readable medium may be a readable signal medium or a readable storage medium. The readable storage medium includes, but is not limited to, for example, electrical, magnetic, optical, electromagnetic, infrared or semiconductor systems, apparatuses or devices, or any combination thereof. More specific instances (a non-exhaustive list) of the readable storage medium include: electrical connection having one or more lead wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

While the general principles of the present disclosure have been described above in conjunction with specific embodiments, the benefits, advantages, effects, and the like mentioned in the present disclosure are merely illustrative and not limiting, and are not to be construed as necessarily required by various embodiments of the present disclosure. In addition, the specific details disclosed above are for the purposes of illustration and convenience in understanding only and are not intended to be limiting, and the above details are not intended to limit the present disclosure to be implemented by necessarily adopting the above specific details.

Various modifications and variations of the present disclosure may be made by those skilled in the art without departing from the spirit and scope of the present application. Thus, it is intended that the present disclosure covers these modifications and variations provided that these modifications and variations of the present application fall within the scope of the claims and equivalents thereof of the present disclosure.

What is claimed is:

1. An audio processing method, comprising:
acquiring a first audio signal in a space of a mobile terminal;
performing separation processing on the first audio signal to obtain at least two paths of second audio signals; and
performing sound effect processing on the at least two paths of second audio signals respectively to correspondingly obtain at least two paths of third audio signals.

2. The method according to claim 1, wherein the performing separation processing on the first audio signal to obtain at least two paths of second audio signals, comprises:
inputting the first audio signal into a first neural network model, and outputting the at least two paths of second audio signals respectively by at least two output channels of the first neural network model.

3. The method according to claim 1, wherein the performing sound effect processing on the at least two paths of second audio signals respectively to correspondingly obtain at least two paths of third audio signals, comprises:
determining a sound effect type corresponding to the at least two paths of second audio signals respectively; and
performing corresponding sound effect processing on the at least two paths of second audio signals based on the sound effect type to correspondingly obtain the at least two paths of third audio signals.

4. The method according to claim 3, wherein the determining a sound effect type corresponding to the at least two paths of second audio signals respectively, comprises:
determining the sound effect type corresponding to the at least two paths of second audio signals according to a first sound effect indication; or
determining the sound effect type corresponding to the at least two paths of second audio signals according to feature information of a user.

5. The method according to claim 4, wherein the feature information of the user comprises multi-modal information of the user; and
the determining the sound effect type corresponding to the at least two paths of second audio signals according to feature information of a user, comprises:
acquiring the sound effect type corresponding to the at least two paths of second audio signals from a sound effect library according to the multi-modal information.

6. The method according to claim 1, further comprising:
performing audio mixing based on the at least two paths of third audio signals to obtain a fourth audio signal.

7. The method according to claim 6, wherein the performing audio mixing based on the at least two paths of third audio signals to obtain a fourth audio signal, comprises:
executing signal superposition on the at least two paths of third audio signals to obtain a fifth audio signal; and
performing audio mixing processing on the fifth audio signal and a preset signal to obtain the fourth audio signal.

8. The method according to claim 6, wherein the acquiring a first audio signal in a space of a mobile terminal, comprises:
acquiring sound signals at a plurality of locations in the space of the mobile terminal by a plurality of acoustic sensors to obtain the first audio signal.

9. The method according to claim 6 wherein the acquiring a first audio signal in a space of a mobile terminal, comprises:
acquiring a sixth audio signal in the space of the mobile terminal; and
eliminating an interference signal in the sixth audio signal to obtain the first audio signal.

10. The method according to claim 9, wherein the eliminating an interference signal in the sixth audio signal to obtain the first audio signal, comprises:
performing interference signal elimination processing on the sixth audio signal based on a reference signal determined based on the fourth audio signal to obtain the first audio signal.

11. The method according to claim 6, further comprising:
playing the fourth audio signal inside the space of the mobile terminal, and/or outside the space of the mobile terminal.

12. A computer-readable storage medium storing a computer program thereon, which, when executed by a processor, cause the processor to execute the following:
acquiring a first audio signal in a space of a mobile terminal;
performing separation processing on the first audio signal to obtain at least two paths of second audio signals; and
performing sound effect processing on the at least two paths of second audio signals respectively to correspondingly obtain at least two paths of third audio signals.

13. Electronic device, comprising:
a processor; and
a memory for storing processor-executable instructions;
wherein the processor is configured for reading the executable instructions from the memory and executing the instructions to perform the following:
acquiring a first audio signal in a space of a mobile terminal;
performing separation processing on the first audio signal to obtain at least two paths of second audio signals; and
performing sound effect processing on the at least two paths of second audio signals respectively to correspondingly obtain at least two paths of third audio signals.

14. The electronic device according to claim 13, wherein the performing separation processing on the first audio signal to obtain at least two paths of second audio signals, comprises:
inputting the first audio signal into a first neural network model, and outputting the at least two paths of second audio signals respectively by at least two output channels of the first neural network model.

15. The electronic device according to claim 13, wherein the performing sound effect processing on the at least two paths of second audio signals respectively to correspondingly obtain at least two paths of third audio signals, comprises:
determining a sound effect type corresponding to the at least two paths of second audio signals respectively; and
performing corresponding sound effect processing on the at least two paths of second audio signals based on the sound effect type to correspondingly obtain the at least two paths of third audio signals.

16. The electronic device according to claim 15, wherein the determining a sound effect type corresponding to the at least two paths of second audio signals respectively, comprises:
determining the sound effect type corresponding to the at least two paths of second audio signals according to a first sound effect indication; or
determining the sound effect type corresponding to the at least two paths of second audio signals according to feature information of a user.

17. The electronic device according to claim 16, wherein the feature information of the user comprises multi-modal information of the user; and
the determining the sound effect type corresponding to the at least two paths of second audio signals according to feature information of a user, comprises:
acquiring the sound effect type corresponding to the at least two paths of second audio signals from a sound effect library according to the multi-modal information.

18. The electronic device according to claim 13, further comprising:
performing audio mixing based on the at least two paths of third audio signals to obtain a fourth audio signal.

19. The electronic device according to claim 18, wherein the performing audio mixing based on the at least two paths of third audio signals to obtain a fourth audio signal, comprises:
executing signal superposition on the at least two paths of third audio signals to obtain a fifth audio signal; and
performing audio mixing processing on the fifth audio signal and a preset signal to obtain the fourth audio signal.

20. The electronic device according to claim 18, wherein the acquiring a first audio signal in a space of a mobile terminal, comprises:
acquiring sound signals at a plurality of locations in the space of the mobile terminal by a plurality of acoustic sensors to obtain the first audio signal.
